(19) United States
(12) Patent Application Publication
(10) Pub. No.: US 2005/0259023 A1
(43) Pub. Date: Nov. 24, 2005

(54) Collapsible indoor television antenna assembly

(75) Inventor: Cheng-Si Wang, Changhua Hsien (TW)

Correspondence Address: NIKOLAI & MERSEREAU, P.A., 900 SECOND AVENUE SOUTH, SUITE 820, MINNEAPOLIS, MN, 55402, US

(73) Assignee: Trans Electric Co., Ltd., Changhua Hsien (TW)

(21) Appl. No.: 10/850,481

(22) Filed: May 20, 2004

(51) Int. Cl. H01Q 3/00

(52) U.S. Cl. 343/764

(57) ABSTRACT

An indoor television antenna assembly includes a base, a UHF antenna and a VHF antenna. The base has a top, a bottom, an annular groove defined in the top and two elongated straight slots defined in the bottom alongside the base. The UHF antenna is adjustably mounted on the top of the base and includes a ring seat rotatably mounted in the rotation recess and a ring antenna pivotally mounted on the ring seat. The VHF antenna is pivotally mounted in the base and includes an inner shaft pivotally mounted in the base and two dipole antennas pivotally respectively mounted on the inner shaft and held respectively in the elongated straight slots. Consequently, the foldable UHF and VHF antennas make the entire indoor television antenna assembly compact to save packaging materials and storage space.

### BACKGROUND OF THE INVENTION

1. Field of the Invention

The present invention relates to an indoor television antenna assembly, and more particularly to an indoor television antenna assembly having both a collapsible VHF antenna set and a collapsible UHF antenna to make the television antenna assembly compact when the UHF and VHF antennas are not in use.

2. Description of Related Art

Indoor television antennas are connected to televisions for receiving radio television signals transmitted from television stations. The radio television signals operate generally at very high frequency (VHF) band and ultrahigh frequency (UHF) band. Therefore, a conventional television needs typically both VHF and UHF antennas to receive respectively the television signals provided at different bands.

The conventional indoor television antenna in accordance with the prior art comprises a base, a VHF antenna set and a UHF antenna. The UHF and VHF antennas are attached to the base and can be spread and adjusted to receive efficiently the television signals. However, the VHF and UHF antennas of the conventional indoor television antenna cannot be completely folded relative to the body and hidden entirely by the body when not in use. The conventional television antenna will need a bulky box to package the entire television antenna inside for storage, transport or selling. Using the bulky box to package the television antenna will waste packaging materials and needs large storage space in stock rooms.

Furthermore, the package box for the conventional television antenna cannot have a specific shape and eye-catching design because the unfolded VHF and UHF antennas extend outward relative to the base. The conventional television antenna packaged with a regular package box cannot attract consumers when the consumers want to purchase the indoor television antennas.

To overcome the shortcomings, the present invention provides a compact indoor television antenna assembly that has both collapsible VHF and UHF antennas for a size reduction when not in use to mitigate or obviate the aforementioned problems.

### SUMMARY OF THE INVENTION

The main objective of the invention is to provide a compact indoor television antenna assembly that has collapsible VHF and UHF antennas for a size reduction when the television antenna assembly is not in use to save packaging materials and storage space.

An indoor television antenna includes a base, a UHF antenna and a VHF antenna set. The base has a top, a bottom, an annular groove defined in the top and two elongated slots defined in the bottom alongside the base. The UHF antenna is pivotally and rotatably mounted on the top of the base and includes a ring seat rotatably mounted in the top of the base and a ring antenna rotatably mounted on the ring seat. The VHF antenna is pivotally mounted in the base and includes an inner shaft pivotally mounted in the base and two dipole antennas pivotally respectively mounted on the inner shaft and held respectively in the elongated slots. Consequently, the foldable UHF and VHF antennas make the entire indoor television antenna assembly compact to reduce packaging size of the antenna assembly to save packaging materials and storage space.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of an indoor television antenna assembly in accordance with the present invention;

FIG. 2 is an operational perspective view of the indoor television antenna assembly in FIG. 1;

FIG. 3 is an operational side plan view of the indoor television antenna assembly in FIG. 1;

FIG. 4 is a bottom plan view of the indoor television antenna assembly in FIG. 1;

FIG. 5 is a sectional plan view of a segment of a base of the indoor television antenna assembly along line 5-5 in FIG. 4; and

FIG. 6 is an operational perspective view of the television antenna assembly in FIG. 1 when the indoor television antenna is packaged in a specific box.

### DETAILED DESCRIPTION OF PREFERRED EMBODIMENT

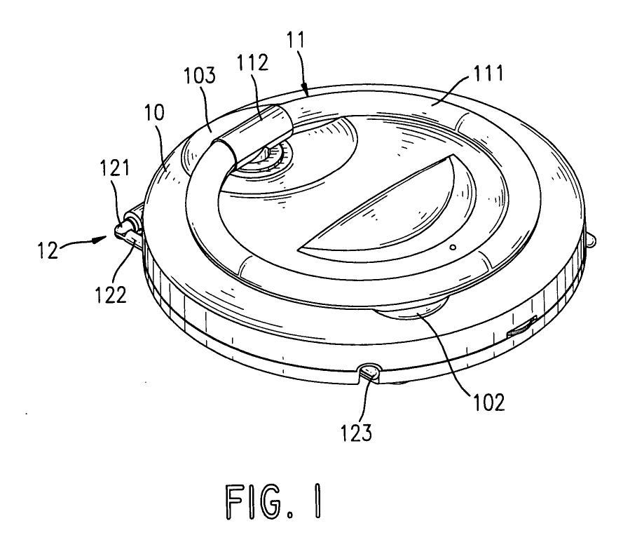

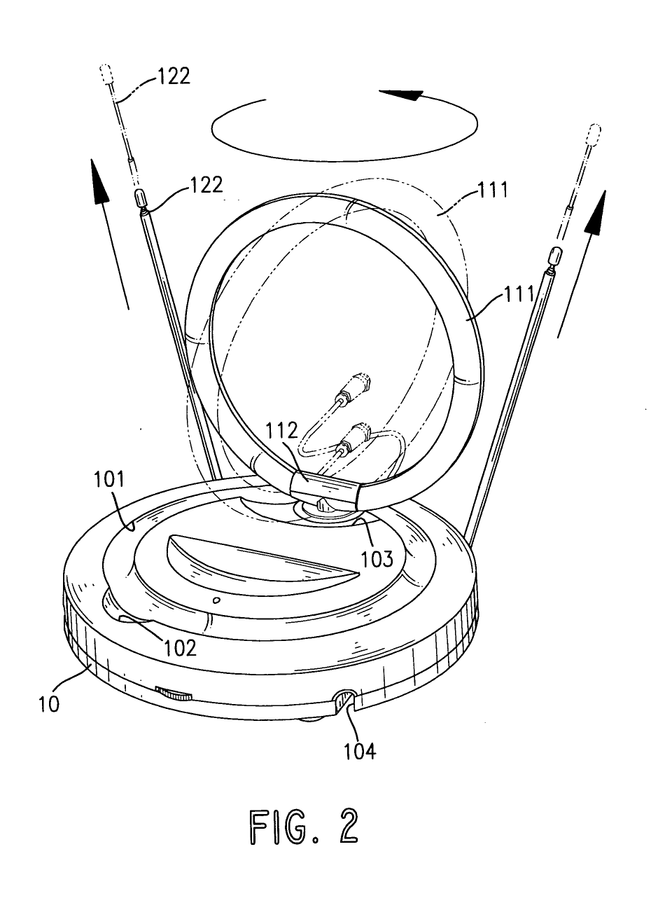

With reference to FIGS. 1 and 2, an indoor television antenna assembly in accordance with the present invention comprises a base (10), a UHF antenna (11) and a VHF antenna set (12).

The base (10) is used to mount on a surface, may be shaped as a hollow thick disk and has a top, a bottom, an annular groove (101), an unfolding recess (102), a rotation recess (103) and two elongated straight slots (104).

The annular groove (101) is defined in the top of the base (10) to receive partially the UHF antenna (11) when the UHF antenna (11) is positioned at a folded position. The unfolding recess (102) is defined in the top of the base (10) outside the annular groove (101), communicates with the annular groove (101) and may be shaped semicircular. A person will easily pick the UHF antenna (11) up through the unfolding recess (102) to spread and adjust the UHF antenna (11) from the folded position to an unfolded position. The rotation recess (103), which may be circular, is defined in the top of the base (10) and overlaps a segment of the annular slot (101) to allow the rotations of the UHF antenna (101) over the top of the base (10).

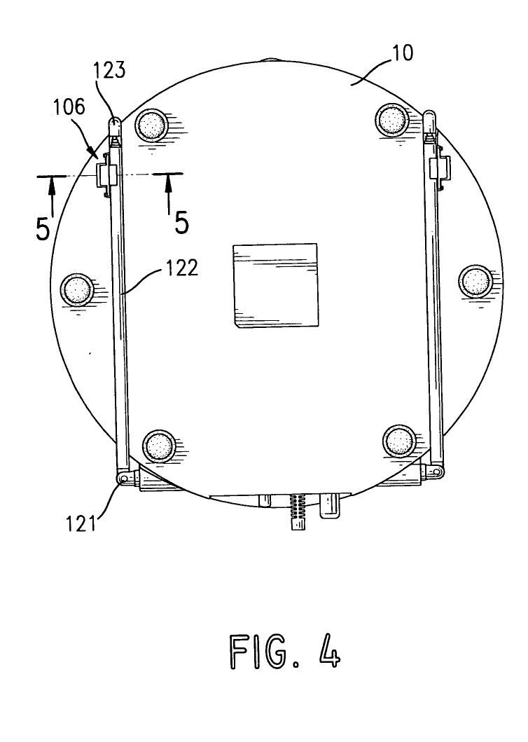

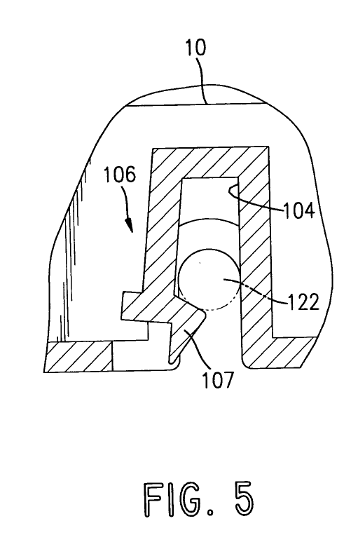

With reference to FIGS. 4 and 5, the elongated straight slots (104) are defined in the bottom of the base (10) and are parallel to each other alongside the base (10). The base (10) further has two clamping devices (106) mounted respectively in the elongated slots (104). Each of the clamping devices (106) comprises a resilient hook (107) that extends toward the associated elongated slot (104).

The UHF antenna (11) is adjustably and foldably mounted on the top of the base (10) at a position in the rotation recess (103) and comprises a ring antenna (111) and a ring seat (112). The ring seat (112) is rotatably mounted in the rotation recess (103). The ring antenna (111) is rotatably mounted on the ring seat (112) and can be pivoted about the ring seat (112) relative to the base (10). Therefore, the ring antenna (111) can be held at either the folded position or the unfolded position and be received in the annular groove (101) when the ring antenna (111) is held at the folded position to hide the UHF antenna (11) in the base (10).

Adjusting azimuth and elevation of the ring antenna (111) is convenient and easy because of the rotatable ring seat (112) and the pivotal relationship between the ring antenna (111) and the ring seat (112).

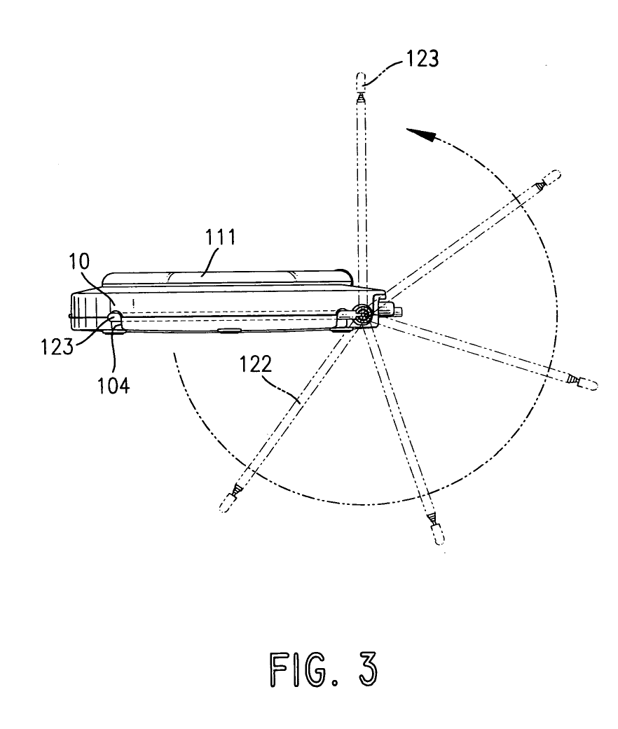

With reference to FIGS. 1, 3, 4 and 5, the VHF antenna set (12) is pivotally mounted in the base (10) adjacent to the rotation recess (103) and comprises an inner shaft (121) and two dipole antennas (122). The inner shaft (121) is rotatably mounted inside the base (10) and has two opposite ends that extend out of the base (10) and correspond respectively to the elongated slots (104) in the bottom of the base (10).

The dipole antennas (122) are telescopic antennas and are respectively pivotally mounted at the opposite ends of the inner shaft (121). The dipole antennas (122) are respectively held in the elongated slots (104), and each of the dipole antennas (122) has a front end (123) extended across the resilient hook (107) in the elongated slot (104) and out of the base (10). Therefore, the resilient hooks (107) will hold respectively the dipole antennas (122) in the elongated slots (104).

A person can remove the dipole antennas (122) from the elongated slots (104) through the front ends (123) when using the dipole antennas (122). The dipole antennas (122) will disengage from the resilient hooks (107) and be upward pivoted about the inner shaft (121) relative to the top of the base (10). The person can draw and extend the telescopic antennas to receive the television signals.

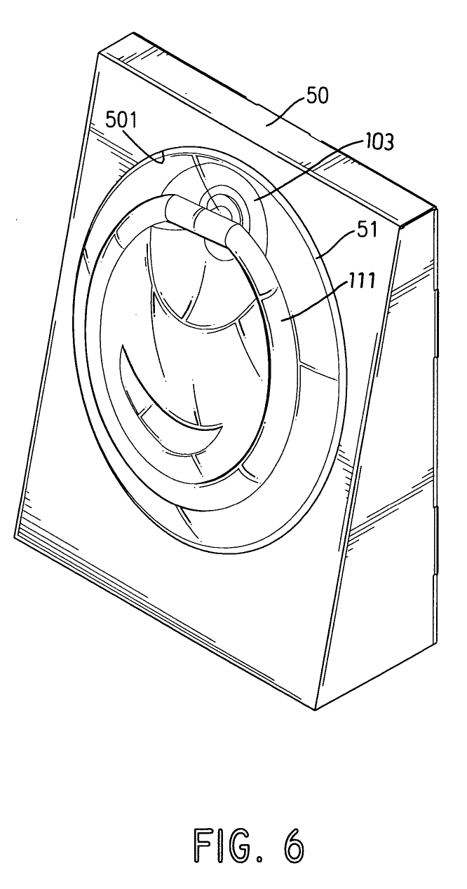

With reference to FIG. 6, the UHF and VHF antennas (11, 12) can be folded and held in the base (10) so that the entire size of the folded indoor television antenna assembly is reduced and compact. The indoor television antenna assembly in accordance with the present invention can use a specific eye-catching package to enclose the antennas. The package comprises an outer paper box (50) and a see-through case (51). The outer paper box (50) has a presentation window (501). The indoor television antenna is mounted in the presentation window (501) and is covered by the see-through case (51) so that the consumers can easily and conveniently select the indoor television antenna when considering purchase in a retail store.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A collapsible indoor television antenna assembly comprising:
a base with a top and a bottom and having
an annular groove defined in the top;
a rotation recess defined in the top and overlapping the annular groove; and
two elongated straight slots defined in the bottom alongside the base;
a UHF antenna pivotally rotatably mounted on the top of the base and comprising
a ring seat rotatably mounted in the rotation recess; and
a ring antenna rotatably mounted on the ring seat and having a folded position as the ring antenna is partially held in the annular groove in the top of the base and an unfolded position;
a VHF antenna set pivotally mounted in the base and comprising
an inner shaft rotatably mounted in the base and having two opposite ends extended out of the base and corresponding respectively to the elongated straight slots in the bottom of the base; and
two dipole antennas pivotally respectively mounted at the opposite ends of the inner shaft and held respectively in the elongated straight slots.

2. The collapsible indoor television antenna assembly as claimed in claim 1, wherein the dipole antennas are telescopic antennas and each of the dipole antennas has a front end extended out of the base.

3. The collapsible indoor television antenna assembly as claimed in claim 1, wherein the base further has an unfolding recess defined in the top of the base outside the annular groove and communicating with the annular groove.

4. The collapsible indoor television antenna assembly as claimed in claim 2, wherein the base further has an unfolding recess defined in the top of the base outside the annular groove and communicating with the annular groove.

5. The collapsible indoor television antenna assembly as claimed in claim 4, wherein the base further comprises two clamping devices mounted respectively in the elongated straight slots in the bottom of the base to hold respectively the dipole antennas in the elongated straight slots in position.

6. The collapsible indoor television antenna assembly as claimed in claim 5, wherein each of the clamping devices comprises a resilient hook extended toward the adjacent elongated straight slot.

7. The collapsible indoor television antenna assembly as claimed in claim 6, wherein the rotation recess is circular.
